(19) United States
(12) Patent Application Publication
(10) Pub. No.: US 2007/0259544 A1
(43) Pub. Date: Nov. 8, 2007

(54) DEVICE FOR HANDLING A COMMUNICATION DEVICE

(76) Inventor: Andreas PEIKER, Friedrichsdorf (DE)

Correspondence Address: BURR & BROWN, PO BOX 7068, SYRACUSE, NY, 13261-7068, US

(21) Appl. No.: 11/777,559

(22) Filed: Jul. 13, 2007

Related U.S. Application Data
(63) Continuation of application No. PCT/DE2005/002300, filed on Dec. 21, 2005.

(30) Foreign Application Priority Data
Jan. 25, 2005 (DE) 10 2005 003 565.5

(51) Int. Cl. H01R 25/00

(52) U.S. Cl. 439/120

(57) ABSTRACT

The invention relates to an arrangement for handling a communication appliance, such as a mobile telephone, personal digital assistant or the like, in particular for use in a vehicle. In this case, a first BT module is integrated in an attachment device and communicates with a second BT module, with the second BT module being connected to a control unit in the vehicle.

### CROSS REFERENCE TO RELATED APPLICATIONS

This application is a continuation of International Application No. PCT/DE2005/002300, filed Dec. 21, 2005, and claims the benefit under 35 USC §119(a)-(d) of German Application No. 10 2005 003 565.5, filed Jan. 25, 2005, the entireties of which are incorporated herein by reference.

### FIELD OF THE INVENTION

The invention relates to an arrangement for handling a communication appliance.

### BACKGROUND OF THE INVENTION

WO 2002/057117 A2 discloses an arrangement for handling a communication appliance, in which a wire-based link exists to components, such as a loudspeaker and microphone, arranged outside the appliance holder.

### SUMMARY OF THE INVENTION

The invention is based on the object of developing an arrangement for handling a communication appliance that simplifies the link to a convenience device provided in the appliance holder.

The arrangement according to the invention for handling a communication appliance provides for a BT module to be integrated in the attachment device for the appliance holder and to communicate with a second BT module which is connected to a control unit in the vehicle. This avoids the need for a physical interface between the attachment device and the components in the vehicle, thus avoiding compatibility problems which can occur as a result of plugs configured to different standards, since a wire-free interface such as this is upwards and downwards compatible, without major complexity, by means of appropriate software. The essence of the invention is the use of BT modules to avoid compatibility problems, and the arrangement of the first BT module in the attachment device. This makes it possible to utilize available physical space which was previously unused, in order to allow existing assemblies to be adopted unchanged.

Throughout the entire application text, the abbreviation “BT module” is used for a module which operates on the basis of the Bluetooth radio standard.

The invention furthermore provides for the BT module to be formed from a BT chip, electronic components and an antenna, with all of the components being arranged on a board. This results in a compact assembly, which allows easy installation.

The invention also provides for the board to be linked to the appliance holder via a plug. Already existing assemblies can thus be used.

Finally, the invention provides for the BT module to be supplied via an electrical power source in the vehicle, and to be addressed via a control line which is connected to the vehicle. A link such as this allows the convenience device to interact with the vehicle control unit and associated vehicle peripherals via the BT module, thus ensuring safety in the vehicle.

### BRIEF DESCRIPTION OF THE DRAWINGS

Further details of the invention are described in the drawing, with reference to a schematically illustrated exemplary embodiment. In this case:

FIG. 1 shows an arrangement according to the invention.

### DETAILED DESCRIPTION THE INVENTION

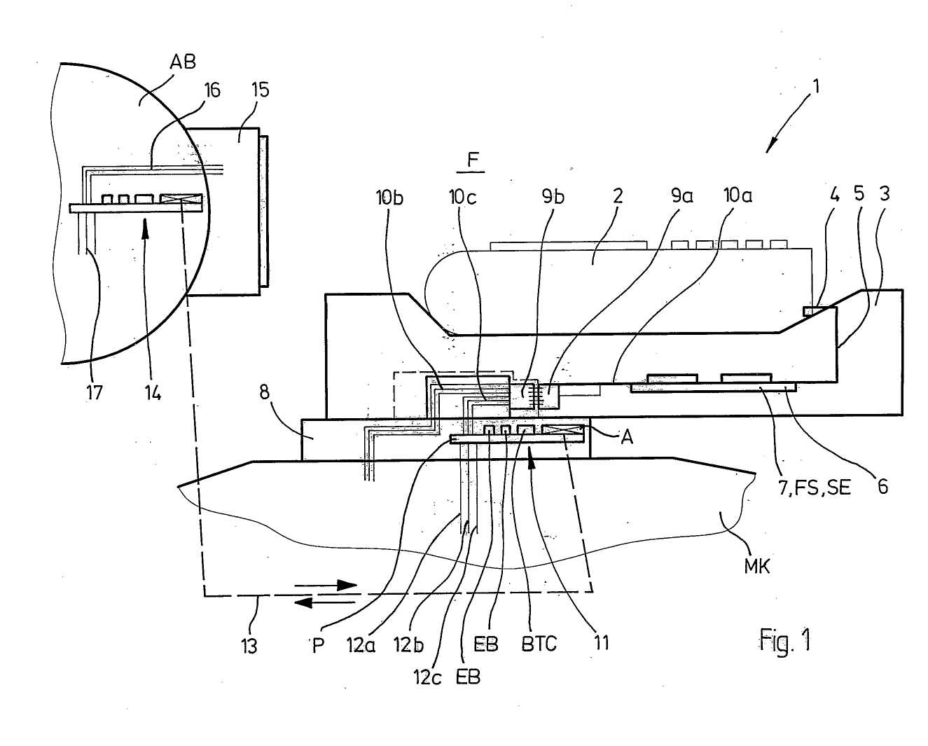

FIG. 1 shows an arrangement 1 for handling a communication appliance or mobile telephone 2 in a vehicle F. The mobile telephone 2 is held in an appliance holder 3 and contact is made with it by means of a first plug 4. Lines 5 which are connected to the mobile telephone 2 via the plug 4 lead to an electronic circuit 6 which is arranged in the appliance holder 3. The electronic circuit 6 is in the form of a convenience device 7 and comprises the functions of a hands-free device FS and/or of voice recognition SE. The appliance holder 3 is detachably plugged onto an attachment device 8, which is mounted on a center console MK in the vehicle F, via plugs 9a and 9b. Plugs 9a and 9b connect to a first cable run 10b and a second cable run 10c in the appliance holder 3, which connect to electronic circuit 6 via lines 10a. The appliance holder 3 is supplied with electrical power from the vehicle F via the cable run 10b. The electronic circuit 6 in the appliance holder 3 is connected for communication purposes via the cable run 10c to a first BT module 11, with the cable run 10c being in the form of a flexible conductor. The BT module 11 comprises a board P, electronic components EB arranged on it, a BT chip BTC and an antenna A. The BT module 11 is supplied with electrical power from the vehicle via lines 12a, 12b, analogously to the appliance holder 3. The BT module 11 can be activated via a signal which is transmitted via a further line 12c. In the active state, the BT module 11 is connected via wireless communications link 13 without the use of wires for communication purposes to a second BT module 14, which is associated with a control unit 15, also referred to as a head unit, which is arranged on a dashboard AB in the vehicle F. The control unit 15 is used for central control of peripherals in the vehicle F, such as a stereo system, navigation system, hands-free device FS, etc, in order to simplify the control of the large number of individual appliances, and to coordinate their interaction. The second BT module 14 has a cable run 16 as a communication link to the control unit 15. The control unit 15 is supplied with electrical power from the vehicle via a further cable run 17. A BT module activation signal can likewise be transmitted via cable run 17. The hands-free device FS and/or speech recognition device SE arranged in the appliance holder 3 interacts with control unit 15 and associated vehicle peripherals without the use of wires via the two BT modules 11 and 14.

The invention is not restricted to the illustrated or described exemplary embodiments. In fact, it covers developments of the invention within the scope of the patent claims. In particular, the invention also provides for other wire-free communication methods to be used instead of a wire-free connection based on the Bluetooth standard.

### LIST OF REFERENCE SYMBOLS

1 Arrangement
2 Mobile telephone
3 Appliance holder, holding shell
4 Plug
5 Lines connected to the mobile telephone 2
6 Electronic circuit
7 Convenience device
8 Attachment device
9a Plug on 8
9b Plug on 8
10a Lines from 6 to 9a
10b First cable run in 8
10c Second cable run in 8
11 BT module
12a, 12b Lines to 11
12c Line to 11
13 Communication link
14 Second BT module
15 Control unit or head unit
16 Cable run
17 Cable run
A Antenna
AB Dashboard
BTC BT Chip
EB Electronic component
F Vehicle
FS Hands-free device
MK Center console
P Board
SE Voice recognition

What is claimed:

1. An arrangement for handling a communication appliance for use in a vehicle, comprising an appliance holder, which holds the communication appliance, and an attachment device, which is mechanically matched to the appliance holder, wherein the appliance holder is geometrically and mechanically matched to the communication appliance and is connected to it for communication purposes, wherein an electronic circuit provided within the appliance holder comprises at least all of the electronic components required for operation and control of a convenience device, universal, mechanical standardization and matching is provided for connection of the appliance holder to the attachment device, and universal electrical standardization and matching of the appliance holder to the attachment device additionally is provided, wherein the attachment device is followed only by electrical and/or electronic components necessary for conveying at least one of speech and data, wherein a first BT module is integrated in the attachment device and communicates with a second BT module that is connected to a control unit in the vehicle, and the two BT modules interact with at least one of a hands-free device and speech recognition device which are arranged in the appliance holder, without the use of wires.

2. The arrangement for handling a communication appliance of claim 1, wherein the BT module comprises a BT chip, electronic components and an antenna which are arranged on a board.

3. The arrangement for handling a communication appliance of claim 2, wherein the board can be connected to the appliance holder via a plug.

4. The arrangement for handling a communication appliance of claim 1, wherein the BT module has an electrical power source in the vehicle, and a control line which is connected to the vehicle.
